(19) United States
(12) Patent Application Publication
(10) Pub. No.: US 2022/0040822 A1
(43) Pub. Date: Feb. 10, 2022

(54) Welding Clamp With Position Shifting Base

(71) Applicant: Fireball Tool Works LLC, Santa Fe Springs, CA (US)

(72) Inventor: Jason A Marburger, Spokane, WA (US)

(73) Assignee: Fireball Tool Works LLC, Santa Fe Springs, CA (US)

(21) Appl. No.: 17/508,210

(22) Filed: Oct. 22, 2021

Related U.S. Application Data
(63) Continuation-in-part of application No. 16/180,886, filed on Nov. 5, 2018.

(51) Int. Cl. B25B 5/12; B25B 5/00; B23K 37/04

(52) U.S. Cl. CPC B25B 5/12; B23K 37/0435; B25B 5/006; B25B 5/003

(57) ABSTRACT

The present invention has a block with a cylindrical stud and a cylindrical hole. A hex-head screw has a screw head portion, a middle portion and a threaded portion. The threaded portion of the hex-head screw can be fitted to the base of a clamp through the cylindrical hole, so that the clamp can freely rotate, using the cylindrical stud as a pivoting point, and the clamp's location on a welding table can be shifted to provide a proper location on the surface of a workpiece. When the clamp handle is engaged, the cylindrical stud binds to a welding table opening, but when the clamp handle is disengaged, the clamp can rotate as the cylindrical stud rotates in the welding table opening.

The present invention claims priority from and is a continuation in part of co-pending United States utility patent entitled Position Shifting Base by same inventor Jason Marburger, filed Nov. 5, 2018 having an application number of Ser. No. 16/180,886 the disclosure of which is incorporated herein by reference.

### FIELD OF THE INVENTION

The present invention is in the field of welding clamps.

### DISCUSSION OF RELATED ART

A variety of different accessories can be attached to a welding table. On such a welding table, clamps can be inserted to the holes on the table top to clamp on workpieces. Generally, the holes on a typical welding table are two inches apart from the one next to it.

Although not analogous, due to its application in woodworking rather than welding, United States Patent Publication to Clark 2016/0046001 by applicant Kreg Enterprises, Inc. published Feb. 18, 2016 shows an expandable locking mechanism with an anchor which includes a mounting plate. A renowned supplier of carpentry equipment, Kreg uses a rotating anchor mechanism that firmly grips to the workbench and a locking clamp that locks the clamp to the workpiece. While the Kreg clamp is superior for overcoming vibrations common to carpentry, it is not well adapted to welding.

### SUMMARY OF THE INVENTION

The invention uses a substantially rectangular block with a cylindrical stud and a cylindrical hole. The cylindrical hole is made in the same axial direction as said cylindrical stud and through the body of said block. A hex-head screw can be inserted through the cylindrical hole to attach the present invention to the bottom of a clamp.

The hex-head screw has an indent hex shape to receive a hex driver. The hex-head screw comprises a screw head portion, a middle portion and a threaded portion. The threaded portion of the hex-head screw can be fitted to the base of a clamp (which will have thread lines matching the thread lines of the threaded portion of the hex-head screw) through the cylindrical hole, so that the clamp can freely rotate, using the cylindrical stud as a pivoting point, and the clamp's location on a welding table can be shifted to provide a proper location on the surface of a workpiece.

In the description given in this application, the up, down, upper, lower, or bottom terms are given in a common perspective where the gravity direction will be down and the opposite direction will be up.

It is an object of the present invention to provide finer adjustment capability for the rectangular array formation welding table openings that are arranged as a regular matrix so as to adapt to small workpieces. It is an object of the present invention to provide an offset and angle to the position of the clamp. It is an object of the present invention to allow a one-handed operation to disengage the clamp and swivel the clamp from the clamp locking handle.

### SUMMARY OF THE CLAIMS

A welding clamp with a position shifting base includes a clamp having a clamp arm with a clamp engaging tip. The clamp arm is mounted at a locking handle pivot, to a clamp locking handle. The clamp arm is locked into an engaged position from a disengaged position via a clamp locking handle, The clamp arm is mounted to a clamp base at a clamp arm pivot. A base holder is formed as a block body and the block body is engaged to the clamp base. A cylindrical stud extends downwardly to a bottom side of the block body. The cylindrical stud is configured to extend into a welding table opening. The block body is configured to rotate freely on the welding table when the clamp is in the disengaged position. The cylindrical stud binds to the welding table opening when the clamp is engaged to the engaged position. A cylindrical hole is made in the same axial direction as the cylindrical stud and through the block body. The cylindrical hole is divided into a upper portion and a lower portion. A screw is sized to fit through the cylindrical hole and the screw is longer than the thickness of the block body and has a screw head portion, a middle portion and a threaded portion. The hex-head screw is installed upside down with the threaded portion extending upwardly above the screw head portion. The threaded portion engages the clamp base.

Preferably, the screw is a hexhead screw. The cylindrical stud has a cylindrical stud sidewall. The cylindrical stud sidewall has a cylindrical stud sidewall coefficient of friction. A surface roughness of the cylindrical stud sidewall is selected to define an appropriate surface roughness to provide a cylindrical stud sidewall coefficient of friction that is high enough to bind the cylindrical stud onto the welding table opening when the clamp locking handle is engaged, but low enough to allow the cylindrical stud to rotate freely within the welding table opening when the clamp locking handle is disengaged.

A diameter of the screw head portion of the hex-head screw is larger than that of a diameter of the middle portion. A diameter of the middle portion is larger than a diameter of the threaded portion, and a diameter of the cylindrical hole's upper portion is sized to fit the middle portion of the hex-head screw. A diameter of the cylindrical hole's lower portion is sized to fit the screw head portion of the hex-head screw. A middle portion of the hex-head screw is not threaded.

The center line of the cylindrical stud and the centerline of the cylindrical hole are at least one inch apart. The screw is tightened so that it rigidly connects the clamp base to the block body. The clamp is configured to allow the cylindrical stud to swivel within the welding table opening in a swivel motion while maintaining a preset angle between the base holder and the clamp base when the clamp is in the disengaged position. The clamp tip has a clamp tip downward line of force parallel to an intermediate screw axis of the screw. The clamp tip downward line of force is offset from the intermediate screw axis of the screw at a clamp tip pivot offset. The base holder forms an angle to the clamp at a clamp base angle. A user can configure the clamp base angle to be facing the user during welding to provide a space for working on small or fine welds.

### DESCRIPTION OF THE DRAWINGS

The accompanying drawings, which are incorporated in and constitute a part of this specification, illustrate and exemplify the preferred embodiments of the invention. Together with the description, serve to explain the principles of the invention.

FIG. 1 is the perspective view of the present invention showing the block and the hex-head screw separated from the body of the block.

FIG. 2 is an exploded view diagram of the present invention.

FIG. 3 is a diagram of a welding table and a clamp engaged to a small workpiece next to a larger workpiece.

The following callout list of elements can be a useful guide in referencing the element numbers of the drawings.

20 Cylindrical Stud

21 Cylindrical Stud Axis

22 Cylindrical Stud Offset

23 Cylindrical Stud Tip

24 Stud Side Wall

25 Cylindrical Stud Forward Lower Face

26 Cylindrical Stud Edge Lower Edge

41 Threaded Portion

42 Middle Portion

43 Intermediate Screw Axis

44 Screw Head Portion

45 Smooth Portion

46 Circumferential Indent

47 Shoulder

48 Hexagonal Head Screw

49 Hexagonal Screw Forward Lower Face

80 Cylindrical Hole

82 Upper Portion

84 Lower Portion

86 Protrusion

91 Locking Handle Pivot

92 Welding Table Opening Sidewall

93 Welding Table Opening Lower Edge

98 Workpiece

100 Rectangular Block

101 Rectangular Block Rear Face

102 Rectangular Block Left Face

103 Rectangular Block Front Face

104 Rectangular Block Right Face

105 Welding Table

706 Table Opening

200 Clamp

201 Clamp Engaging Tip

202 Clamp Base

203 Clamp Attachment

204 Clamp Locking Handle

205 Clamp Adjustment Knob

206 Clamp Arm

207 Clamp Arm Pivot

208 Clamp Tip Downward Line of Force

209 Clamp Tip Pivot Offset

210 Clamp Base Angle

211 Clip Tip Forward Line of Force

212 Rectangular Block Orientation Line

213 Clamp Base Orientation Line

### DETAILED DESCRIPTION OF THE PREFERRED EMBODIMENT

The position shifting base of present invention has a substantially rectangular block 100, a cylindrical stud 20 extending from a bottom side of said block 100, and a cylindrical hole 80.

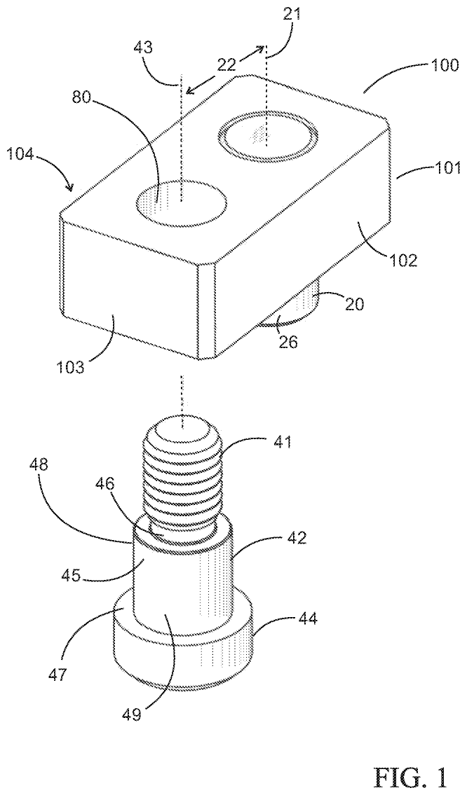

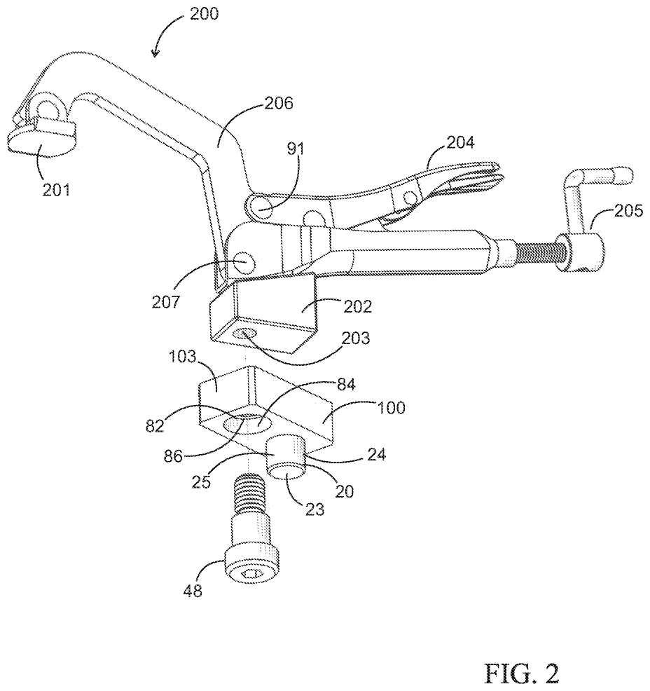

The diameter of the cylindrical stud 20 is made to match the diameter of the holes on a typical welding table top. When the cylindrical stud 20 is inserted into a hole on a welding table, the block 100 is free to rotate on the welding table. The cylindrical hole 80 is made in the same axial direction as said cylindrical stud 20 and through the body of said block 100, as depicted in FIGS. 1 and 2.

Also as seen in FIG. 1, a base holder such as the rectangular block 100 has orthogonal vertical sidewalk including a rectangular block rear face 101, a rectangular block left face 102, a rectangular block front face 103, and a rectangular block right face 104. Although the base holder could be formed as a differently shaped block, the rectangular block 100 is preferred because it provides the welder with a visual indication of the orientation of the base holder relative to the clamp base 202.

The cylindrical stud axis 21 and the screw axis 43 are parallel to each other and set off from each other at the cylindrical stud offset 22 which is a constant distance between the cylindrical stud axis 21 and the screw axis 43. The cylindrical stud 20 has a cylindrical stud lower edge 26. The hexagonal head screw 48 has a threaded portion 41, a middle portion 42 and a screw head portion 44. The middle portion 42 has a hex head screw forward lower face 49. The smooth portion 45 of the middle portion 42 has a hex head screw forward lower face 49. The smooth portion 45 and the screw head portion 44 have a shoulder 47 formed there between. The middle portion 42 has a larger diameter than the threaded portion 41, and the middle portion 42 has a small diameter than the screw head portion 44. Between the threaded portion 41 and the middle portion 42 a circumferential indent 46 can be machined to provide an indented groove.

The cylindrical hole 80 is divided into an upper portion 82 and a lower portion 84. A hex-head screw 48 is sized to fit through the cylindrical hole 80 and the hex-head screw 48 has a screw head portion 44, a middle portion 42 and a threaded portion 41.

A clamp 200 can be mounted to the block 100 by the threaded portion 41 of the hex-head screw 48. The length of the hex-head screw 48 is longer than the thickness of the body of the block 100, as shown in FIG. 2, and the threaded portion 41 will protrude out from the block 100 and for threadingly attaching to a clamp 200. The length of the screw head portion 44 can be made to be slightly shorter than the length of the lower portion 84 of the cylindrical hole 80, and the length of the middle portion 42 can be made to be slightly longer than the upper portion 82 of the cylindrical hole 80.

The diameter of the screw head portion 44 is larger than that of the middle portion 42; the diameter of the middle portion 42 is larger than that of the threaded portion 41. The diameter of the upper portion 82 of the cylindrical hole 80 is sized to fit the middle portion 42 of the hex-head screw 48. The diameter of the lower portion 84 of the cylindrical hole 80 is sized to fit the screw head portion 44 of the hex-head screw 48. The center line of the cylindrical stud 20 and the centerline of the cylindrical hole 80, as shown in FIG. 1, are one inch apart.

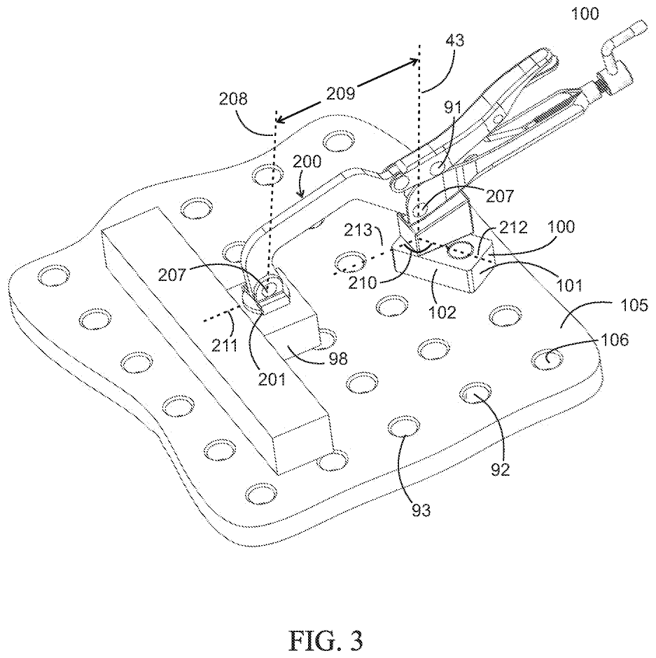

FIG. 3 shows a clamp being set up to clamp a small workpiece next to a large workpiece with the present invention mounted between the base of the clamp and a hole on a welding table. The base of the clamp has a threaded hole matching the dimensions of the threaded portion of the hex-head screw. As shown, the clamp is free to rotate on the present invention even after tightening the hex-head screw to the base of the clamp.

Also as seen in FIG. 3, the welding table 105 has cylindrical openings formed as welding table openings 106 for receiving the cylindrical studs 20. The welding table openings 106 have welding table openings sidewalls 92 which have a frictional engagement to the cylindrical studs 20 such that the cylindrical studs 20 can rotate in the cylindrical openings of the welding table openings 106, while allowing binding of the cylindrical studs 20 to the welding table openings 106 when the clamp locking handle 204 is engaged to an engaged position from a disengaged position. The welding table openings 106 have a welding table opening lower edge 93.

During operation, a workpiece 98 is placed under the clamp engagement tip 201 and the workpiece 98 is frictionally engaged under the clamp engagement tip 201. The clamp engagement tip 201 pushes downwardly such that the clamp engagement tip 201 has a clamping force between itself and the welding table 105. The clamp engagement tip 201 is pivot mounted at a clamp tip pivot 207 to the clamp arm 206. The clamp engaging tip 201 defines a clamp tip downward line of force 208 through the clamp engaging tip 201 when the clamp locking handle 204 engages to an engaged position. When the clamp locking handle 204 engages to an engaged position, the intermediate screw axis 43 passing through the clamp attachment 203, the clamp tip pivot 207 and the threaded portion 41, is parallel to the clamp tip downward line of force 208. A clamp tip pivot offset 209 is the distance formed between the clamp tip downward line of force 208 and the intermediate screw axis 43. The screw such as the hex head screw 48 receives a tilting torque that presses the hex head screw forward lower face 49 towards the lower portion 84 of the cylindrical hole 80. When the tilting torque is applied, the screw may not be perfectly vertically aligned but should remain generally vertical in orientation. The torque, or rotational force, also called a lever force arises when the clamp locking handle 204 is engaged.

A rectangular block orientation line 212 makes a clamp base angle 210 with the clamp base orientation line 213. During operation, a user can adjust the clamp base angle 210 and lock the clamp base angle 210 using the hex head screw 48. The user can also unlock the clamp base angle 210. The clamp base angle 210 is the angle between the clamp base 202 and the holder formed as a rectangular block body 100. With the user definable preset clamp base angle 210, the location of the clamp 200 has an angle adjustment which allows it to mount to locations that are not over the welding table openings.

The clamp tip may also have a clamp tip forward line of force 211. The clamp tip forward line of force 211 would be parallel to the clamp arm plane of movement, and form the clamp base angle 210 between itself and the rectangular block line of orientation that passes through the rectangular block from the cylindrical stud axis 21 to the intermediate screw axis 43. The cylindrical stud 20 does not slip out when the clamp locking handle 204 is engaged. The cylindrical stud 20 also receives a tilting torque that tilts the cylindrical stud lower edge 26 towards the welding table opening lower edge 93. The cylindrical stud 20 thus has a cylindrical stud sidewall 24 of an appropriate surface roughness to define a coefficient of friction that is low enough to allow ease of rotation using single-handed operation when the clamp locking handle 204 is disengaged. The surface roughness of the cylindrical stud sidewall 24 is also of an appropriate surface roughness to define a coefficient of friction that is high enough to bind the cylindrical stud 20 into the welding table opening 106 when the clamp locking handle 204 is engaged. Preferably, the hex head screw 48 is tightened so that it is rigidly connecting the clamp base 202 to the rectangular block 100.

Thus, a user can place a workpiece with a left hand, and swivel the clamp over the workpiece with the right hand, and then clamp the workpiece with the right hand all while not letting go of the workpiece with the left hand and not letting go of the clamp handle with the right hand. The user can then weld. After welding, the user can unclamp and swivel the clamp away from the workpiece with the right hand while holding the workpiece with the left hand.

The clamp base angle 210 may allow more clearance for the user to work because the clamp is set at an angle further away from the user to define a concave profile. The clamp base angle 210 also provides angular adjustment when the intermediate screw axis 43 of the clamp 200 must be placed between table welding openings 106. The clamp base angle 210 is a preset angle, and the user can swivel the clamp 200 when in the disengaged position while maintaining the preset angle of the clamp base angle 210. Thus the user can swivel the clamp base at the cylindrical stud 20 which forms an axis of rotation for the clamp base after the clamp base is secured to the base holder formed as the rectangular block or a differently shaped block body.

1. A welding clamp with a position shifting base, comprising:
a clamp having a clamp arm with a clamp engaging tip, wherein the clamp arm is mounted at a locking handle pivot to a clamp locking handle, wherein the clamp arm is locked into an engaged position from a disengaged position via a clamp locking handle, wherein the clamp arm is mounted to a clamp base at a clamp arm pivot:
a base holder formed as a block body, wherein the block body is engaged to the clamp base;
a cylindrical stud extending downwardly to a bottom side of the block body, wherein the cylindrical stud is configured to extend into a welding table opening, wherein the block body is configured to rotate freely on the welding table when the clamp is in the disengaged position, wherein the cylindrical stud binds to the welding table opening when the clamp is engaged to the engaged position;
a cylindrical hole made in the same axial direction as the cylindrical stud and through the block body, wherein the cylindrical hole is divided into a upper portion and a lower portion; and
a screw, wherein the screw is sized to fit through the cylindrical hole wherein the screw is longer than the thickness of the block body and comprises a screw head portion, a middle portion and a threaded portion, wherein the screw is installed upside down with the threaded portion extending upwardly above the screw head portion, wherein the threaded portion engages the clamp base.

2. The welding clamp with a position shifting base of claim 1, wherein the screw is a hexhead screw.

3. The welding clamp with a position shifting base of claim 1, wherein the cylindrical stud has a cylindrical stud sidewall, and wherein the cylindrical stud sidewall has a cylindrical stud sidewall coefficient of friction, wherein a surface roughness of the cylindrical stud sidewall is selected to define an appropriate surface roughness to provide a cylindrical stud sidewall coefficient of friction that is high enough to bind the cylindrical stud onto the welding table opening when the clamp locking handle is engaged, but low enough to allow the cylindrical stud to rotate freely within the welding table opening when the clamp locking handle is disengaged.

4. The welding clamp with a position shifting base of claim 1, wherein a diameter of the screw head portion of the hex-head screw is larger than that of a diameter of the middle portion, and wherein a diameter of the middle portion is larger than a diameter of the threaded portion, and wherein a diameter of the cylindrical hole's upper portion is sized to fit the middle portion of the hex-head screw, and wherein a diameter of the cylindrical hole's lower portion is sized to fit the screw head portion of the hex-head screw, wherein a middle portion of the hex-head screw is not threaded.

5. The position shifting base for a welding table of claim 1, wherein the center line of the cylindrical stud and the centerline of the cylindrical hole are at least one inch apart.

6. The position shifting base for a welding table of claim 1, wherein the screw is tightened so that it rigidly connects the clamp base to the block body.

7. The position shifting base for a welding table of claim 1, wherein the clamp is configured to allow the cylindrical stud to swivel within the welding table opening in a swivel motion while maintaining a preset angle between the base holder and the clamp base when the clamp is in the disengaged position.

8. The position shifting base for a welding table of claim 1, wherein the clamp tip has a clamp tip downward line of force parallel to an intermediate screw axis of the screw, wherein the clamp tip downward line of force is offset from the intermediate screw axis of the screw at a clamp tip pivot offset.

9. The position shifting base for a welding table of claim 1, wherein the base holder forms an angle to the clamp at a clamp base angle, whereby a user can configure the clamp base angle to be facing the user during welding.

10. The welding clamp with a position shifting base of claim 9, wherein the screw is a hexhead screw.

11. The welding clamp with a position shifting base of claim 9, wherein the cylindrical stud has a cylindrical stud side wall, and wherein the cylindrical stud sidewall has a cylindrical stud sidewall coefficient of friction, wherein a surface roughness of the cylindrical stud sidewall is selected to define an appropriate surface roughness to provide a cylindrical stud sidewall coefficient of friction that is high enough to bind the cylindrical stud onto the welding table opening when the clamp locking handle is engaged, but low enough to allow the cylindrical stud to rotate freely within the welding table opening when the clamp locking handle is disengaged.

12. The welding clamp with a position shifting base of claim 9, wherein a diameter of the screw head portion of the hex-head screw is larger than that of a diameter of the middle portion, and wherein a diameter of the middle portion is larger than a diameter of the threaded portion, and wherein a diameter of the cylindrical hole's upper portion is sized to fit the middle portion of the hex-head screw, and wherein a diameter of the cylindrical hole's lower portion is sized to fit the screw head portion of the hex-head screw, wherein a middle portion of the hex-head screw is not threaded.

13. The position shifting base for a welding table of claim 9, wherein the center line of the cylindrical stud and the centerline of the cylindrical hole are at least one inch apart.

14. The position shifting base for a welding table of claim 9, wherein the screw is tightened so that it rigidly connects the clamp base to the block body.

15. The position shifting base for a welding table of claim 9, wherein the clamp is configured to allow the cylindrical stud to swivel within the welding table opening in a swivel motion while maintaining a preset angle between the base holder and the clamp base when the clamp is in the disengaged position.

16. The position shifting base for a welding table of claim 9, wherein the clamp tip has a clamp tip downward line of force parallel to an intermediate screw axis of the screw, wherein the clamp tip downward line of force is offset from the intermediate screw axis of the screw at a clamp tip pivot offset.
